(19) United States
(12) Patent Application Publication
(10) Pub. No.: US 2003/0065503 A1
(43) Pub. Date: Apr. 3, 2003

(54) Multi-lingual transcription system

(75) Inventors: Lalitha Agnihotri, Fishkill, NY (US); Thomas F. McGee, Garrison, NY (US); Nevenka Dimitrova, Yorktown Heights, NY (US)

Correspondence Address: Corporate Patent Counsel:, U.S. Philips Corporation, 580 White Plains Road, Tarrytown, NY, 10591, US

(73) Assignee: Philips Electronics North America Corp.

(21) Appl. No.: 09/966,404

(22) Filed: Sep. 28, 2001

(51) Int. Cl. G06F 17/28

(52) U.S. Cl. 704/7

(57) ABSTRACT

A multi-lingual transcription system for processing a synchronized audio/video signal containing an auxiliary information component from an original language to a target language is provided. The system filters text data from the auxiliary information component, translates the text data into the target language and displays the translated text data while simultaneously playing an audio and video component of the synchronized signal. The system additionally provides a memory for storing a plurality of language databases which include a metaphor interpreter and thesaurus and may optionally include a parser for identifying parts of speech of the translated text. The auxiliary information component can be any language text associated with an audio/video signal, i.e., video text, text generated by speech recognition software, program transcripts, electronic program guide information, closed caption text, etc.

### BACKGROUND OF THE INVENTION

1. Field of the Invention

The present invention relates generally to a multi-lingual transcription system, and more particularly, to a transcription system which processes a synchronized audio/video signal containing an auxiliary information component from an original language to a target language. The auxiliary information component is preferably a closed captioned text signal integrated with the synchronized audio/video signal.

2. Background of the Invention

Closed captioning is an assistive technology designed to provide access to television for persons who are deaf and hard of hearing. It is similar to subtitles in that it displays the audio portion of a television signal as printed words on a television screen. Unlike subtitles, which are a permanent image in the video portion of the television signal, closed captioning is hidden as encoded data transmitted within the television signal, and provides information about background noise and sound effects. A viewer wishing to see closed captions must use a set-top decoder or a television with built-in decoder circuitry. The captions are incorporated in the line 21 data area found in the vertical blanking interval of the television signal. Since July 1993, all television sets sold in the United States with screens thirteen inches or larger have had built-in decoder circuitry, as required by the Television Decoder Circuitry Act.

Some television shows are captioned in real time, i.e., during a live broadcast of a special event or of a news program where captions appear just a few seconds behind the action to show what is being said. A stenographer listens to the broadcast and types the words into a special computer program that formats the captions into signals, which are then output for mixing with the television signal. Other shows carry captions that get added after the show is produced. Caption writers use scripts and listen to a show's soundtrack so they can add words that explain sound effects.

In addition to assisting the hearing-impaired, closed captioning can be utilized in various situations. For example, closed captioning can be helpful in noisy environments where the audio portion of a program cannot be heard, i.e., an airport terminal or railroad station. People advantageously use closed captioning to learn English or to learn to read. To this end, U.S. Pat. No. 5,543,851 (the '851 patent) issued to Wen F. Chang on Aug. 6, 1996 discloses a closed captioning processing system which process a television signal having caption data therein. After receiving a television signal, the system of the '851 patent removes the caption data from the television signal and provides it to a display screen. A user then selects a portion of the displayed text and enters a command requesting a definition or translation of the selected text. The entirety of the captioned data is then removed from the display and the definition and/or translation of each individual word is determined and displayed.

While the system of the '851 patent utilizes closed captions to define and translate individual words, it is not an efficient learning tool since the words are translated out of context from the manner in which they are being used. For example, a single word would be translated without regard to its relation to sentence structure or whether it was part of a word group representing a metaphor. Additional, since the system of the '851 patent removes the captioned text while displaying the translation, a user must forego portions of the show being watched to read the translation. The user must then return to the displayed text mode to continue viewing the show, which remains in progress.

### SUMMARY OF THE INVENTION

It is therefore an object of the present invention to provide a multi-lingual transcription system which overcomes the disadvantages of the prior art translation system.

It is another object of the present invention to provide a system and method for translating auxiliary information, e.g., closed captions, associated with a synchronized audio/video signal to a target language for displaying the translated information while simultaneously playing the audio/video signal.

It is a further object of the present invention to provide a system and method for translating auxiliary information associated with a synchronized audio/video signal where the auxiliary information is analyzed to remove ambiguities, such as metaphors, slang, etc., and to identify parts of speech as to provide an effective tool for learning a new language.

To achieve the above objects, a multi-lingual transcription system is provided. The system includes a receiver for receiving a synchronized audio/video signal and a related auxiliary information component; a first filter for separating the signal into an audio component, a video component and the auxiliary information component; where necessary, the same or second filter for extracting text data from said auxiliary information component; a microprocessor for analyzing said text data in an original language in which the text data was received; the microprocessor programmed to run translation software that translates said text data into a target language and formats the translated text data with the related video component; a display for displaying the translated text data while simultaneously displaying the related video component; and an amplifier for playing the related audio component of the signal. The system additionally provides a storage means for storing a plurality of language databases which include a metaphor interpreter and thesaurus and may optionally include a parser for identifying parts of speech of the translated text. Furthermore, the system provides for a text-to-speech synthesizer for synthesizing a voice representing the translated text data.

The auxiliary information component can comprise any language text associated with an audio/video signal, i.e., video text, text generated by speech recognition software, program transcripts, electronic program guide information, closed caption text, etc. The audio/video signal associated with the auxiliary information component can be an analog signal, digital stream or any other signal capable of having multiple information components known in the art.

The multi-lingual transcription system of the present invention can be embodied in a stand-alone device such as a television set, a set-top box coupled to a television or computer, a server or a computer-executable program residing on a computer.

According to another aspect of the present invention, a method for processing an audio/video signal and a related auxiliary information component is provided. The method includes the steps of receiving the signal; separating the signal into an audio component, a video component and the auxiliary information component; when necessary, separating text data from the auxiliary information component; analyzing the text data in an original language in which the signal was received; translating the text data into a target language; synchronizing the translated text data with the related video component; and displaying the translated text data while simultaneously displaying the related video component and playing the related audio component of said signal. It is to be appreciated that the text data can be separated from the originally received signal without separating the signal into its various components or that the text data can be generated by a speech-to-text conversion. Additionally, the method provides for analyzing the original text data and translated text data, determining whether a metaphor or slang term is present, and replacing the metaphor or slang term with standard terms representing the intended meaning. Further, the method provides for determining a part of speech the text data is classified as and displaying the part of speech classification with the displayed translated text data.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating a multi-lingual transcription system in accordance with the present invention;

FIG. 2 is a flow chart illustrating a method for processing a synchronized audio/video signal containing an auxiliary information component in accordance with the present invention.

### DETAILED DESCRIPTION OF THE PREFERRED EMBODIMENTS

Preferred embodiments of the present invention will be described hereinbelow with reference to the accompanying drawings. In the following description, well-known functions or constructions are not described in detail to avoid obscuring the invention with unnecessary detail.

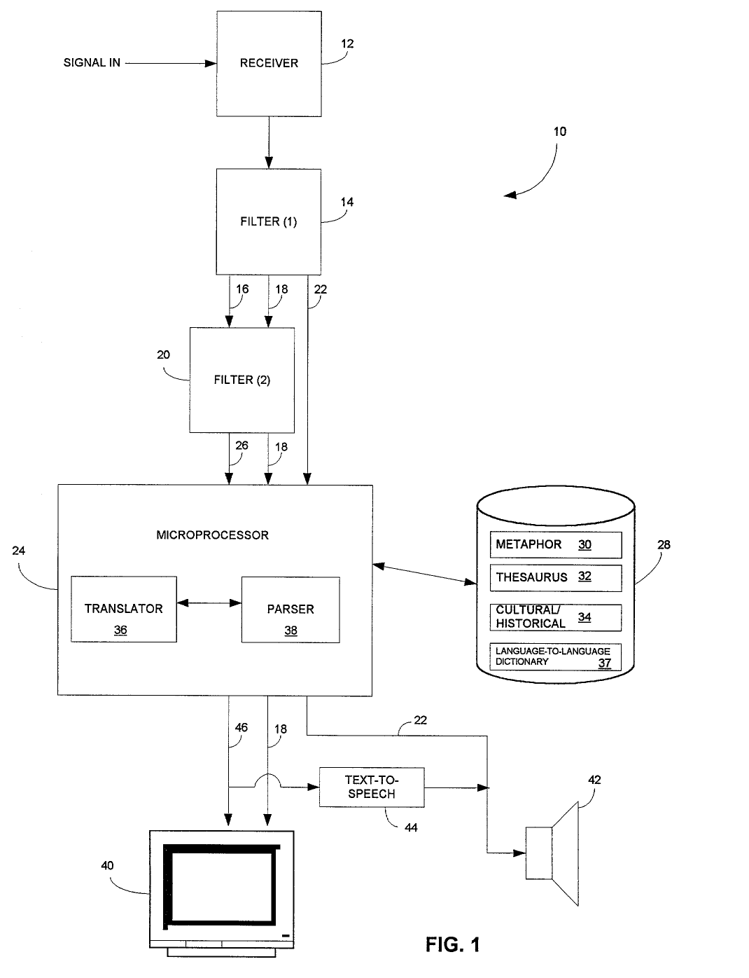

With reference to FIG. 1, a system 10 for processing a synchronized audio/video signal containing a related auxiliary information component according to the present invention is shown. The system 10 includes a receiver 12 for receiving the synchronized audio/video signal. The receiver can be an antenna for receiving broadcast television signals, a coupler for receiving signals from a cable television system or video cassette recorder, a satellite dish and down converter for receiving a satellite transmission, or a modem for receiving a digital data stream via a telephone line, DSL line, cable line or wireless connection.

The received signal is then sent to a first filter 14 for separating the received signal into an audio component 22, a video component 18 and the auxiliary information component 16. The auxiliary information component 16 and video component 18 are then sent to a second filter 20 for extracting text data from the auxiliary information component 16 and video component 18. Additionally, the audio component 22 is sent to a microprocessor 24, the functions of which will be described below.

The auxiliary information component 16 can include transcript text that is integrated in an audio/video signal, for example, video text, text generated by speech recognition software, program transcripts, electronic program guide information, and closed caption text. In general, the textual data is temporally related or synchronized with the corresponding audio and video in the broadcast, datastream, etc. Video text is superimposed or overlaid text displayed in a foreground of a display, with the image as a background. Anchor names in a television news program, for example, often appear as video text. Video text may also take the form of embedded text in a displayed image, for example, a street sign that can be identified and extracted from the video image through an OCR (optical character recognition)-type software program. Additionally, the audio/video signal carrying the auxiliary information component 16 can be an analog signal, digital stream or any other signal capable of having multiple information components known in the art. For example, the audio/video signal can be a MPEG stream with the auxiliary information component embedded in the user data field. Moreover, the auxiliary information component can be transmitted as a separate, discrete signal from the audio/video signal with information, e.g., timestamp, to correlate the auxiliary information to the audio/video signal.

Referring again to FIG. 1, it is to be understood that the first filter 14 and second filter 20 can be a single integral filter or any known filtering device or component that has the capability to separate the above-mentioned signals and to extract text from an auxiliary information component where required. For example, in the broadcast television signal case, there will be a first filter to separate the audio and video and eliminate a carrier wave, and a second filter to act as an A/D converter and a demultiplexer to separate the auxiliary information from the video. On the other hand, in a digital television signal case, the system may be comprised of a single demultiplexer which functions to separate the signals and extract text data therefrom.

The text data 26 is then sent to the microprocessor 24 along with the video component 18. The text data 26 is then analyzed by software in the microprocessor 24 in the original language in which the audio/video signal was received. The microprocessor 24 interacts with a storage means 28, i.e., a memory, to perform several analyses of the text data 26. The storage means 28 may include several databases to assist the microprocessor 24 in analyzing the text data 26. One such database is a metaphor interpreter 30, which is used to replace metaphors found in the extracted text data 26 with a standard term representing the intended meaning. For example, if the phrase “once in a blue moon” appears in the extracted text data 26, it will be replaced with the terms “very rare”, thus preventing the metaphor from becoming incomprehensible when it is later translated into a foreign language. Other such databases may include a thesaurus database 32 to replace frequently occurring terms with different terms having similar meanings and a cultural/historical database 34 to inform the user of the term's significance, for example, in translating from Japanese, emphasizing to the user that the term is a “formal” way of addressing elders or is proper for addressing peers.

The difficulty level of the analysis of the text data can be set by a personal preference level of the user. For example, a new user to the system of the present invention may set the difficulty level “low”, wherein when a word is substituted using the thesaurus database, a simple word is inserted. As opposed to when the difficulty level is set “high”, a multi-syllable word or complex phase may be inserted for the word being translated. Additionally, the personal preference level of a particular user will automatically increase in difficulty after a level has been mastered. For example, the system will adaptively learn to increase the difficulty level for a user after the user has experienced a particular word or phrase a predetermined number of times, wherein the predetermined number of times can be set by the user or pre-set defaults.

After the extracted text data 26 has been analyzed and processed to remove ambiguities by the metaphor and any other databases that may correct grammar, idioms, colloquialisms, etc., the text data 26 is translated by a translator 36 comprised of translation software, which may be a separate component of the system or a software module controlled by the microprocessor 24, in a target language. Further, the translated text may be processed by a parser 38 which describes the translated text by identifying its part of speech (i.e., noun, verb, etc.) form and syntactical relationships in a sentence. The translator 36 and parser 38 may rely on a language-to-language dictionary database 37 for processing.

It is to be understood that the analysis performed by the microprocessor 24 in association with the various databases 30, 32, 34, 37 can be operated on the translated text (i.e., in the foreign language) as well as the extracted text data prior to translation. For example, the metaphor database may be consulted to substitute a metaphor for traditional text in the translated text. Additionally, the extracted text data can be processed by the parser 38 prior to translation.

The translated text data 46 is then formatted and correlated to the related video and sent to a display 40, along with the video component 18 of the originally received signal, to be displayed simultaneously with the corresponding video while also playing the audio component 22 through audio means 42, i.e., an amplifier. Accordingly, appropriate delays in transmission may be made to synchronize the translated text data 46 with the pertinent audio and video.

Optionally, the audio component 22 of the originally received signal could be muted and the translated text data 46 processed by a text-to-speech synthesizer 44 to synthesize a voice representing the translated text data 46 to essentially “dub” the program into the target language. Three possible modes for the text-to-speech synthesizer include: (1) pronouncing only words indicated by the user; (2) pronouncing all translated text data; and (3) pronouncing only words of a certain difficulty level, e.g., multi-syllable words, as determined by a personal preference level set by the user.

Furthermore, the results produced by the parser 38 and the microprocessor 24 in interaction with the cultural/historical database 34 may be displayed on the display 40 simultaneously with the pertinent video component 18 and translated text data 46 to facilitate the learning of a new language.

The multi-lingual transcription system 10 of the present invention can be embodied in a stand-alone television where all system components reside in the television. The system can also be embodied as set-top box coupled to a television or computer where the receiver 12, first filter 14, second filter 20, microprocessor 24, storage means 28, translator 36, parser 38, and text-to-speech converter 44 are contained in the set-top box and the display means 40 and audio means 42 are provided by the television or computer.

User activation and interaction with the multi-lingual transcription system 10 of the present invention can be accomplished through a remote control similar to the type of remote control used in conjunction with a television. Alternatively, the user can control the system by a keyboard coupled to the system via a hard-wire or wireless connection. Through user interaction, the user can determine when the cultural/historical information should be displayed, when the text-to-speech converter should be activated for dubbing, and at what level of difficulty the translation should be processed, i.e., personal preference level. Additionally, the user can enter country codes to activate particular foreign language databases.

In another embodiment of the multi-lingual transcription system of the present invention, the system has access to the Internet through an Internet Service Provider. Once the text data has been translated, the user can perform a search on the Internet using the translated text in a search query. A similar system for performing an Internet search using the text derived from the auxiliary information component of an audio/video signal was disclosed in U.S. application Ser. No. 09/627,188 entitled “TRANSCRIPT TRIGGERS FOR VIDEO ENHANCEMENT” (Docket No. US000198) filed on Jul. 27, 2000 by Thomas McGee, Nevenka Dimitrova, and Lalitha Agnihotri, which is owned by a common assignee and the contents of which are hereby incorporated by reference. Once the search is performed, the search results are displayed on the display means 40 either as a web page or a portion thereof or superimposed over the image on the display. Alternatively, a simple Uniform Resource Locator (URL), an informative message or a non-text portion of a web page, such as images, audio and video, is returned to the user.

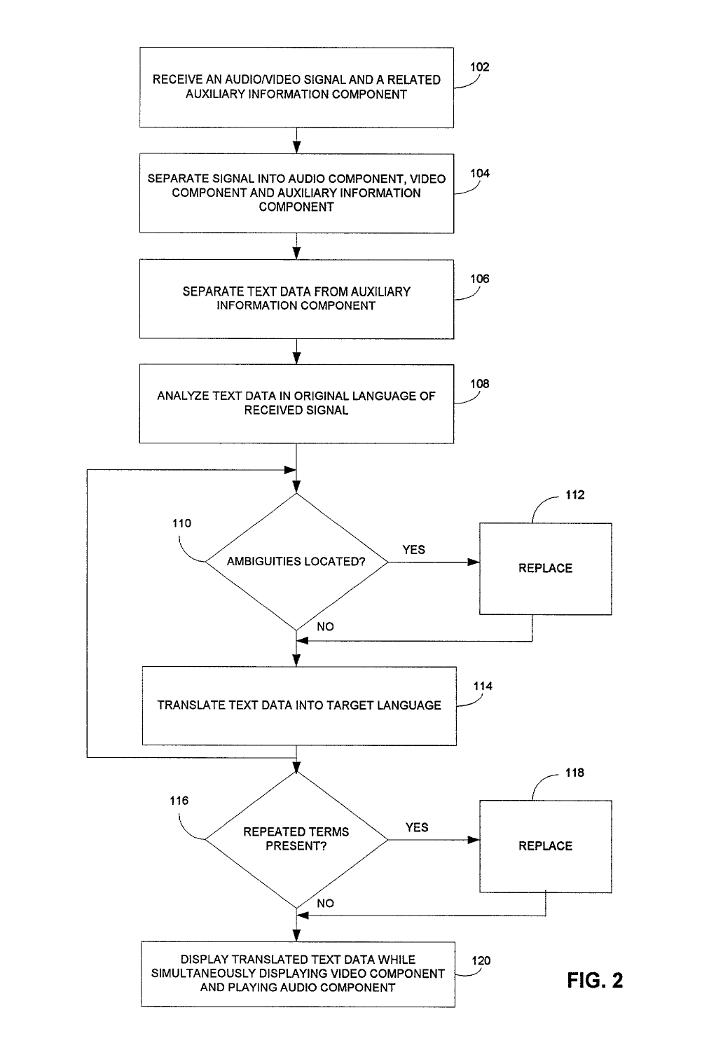

Although a preferred embodiment of the present invention has been described above with regard to a preferred system, embodiments of the invention can be implemented using general purpose processors or special purpose processors operating under program control, or other circuits, for executing a set or programmable instructions adapted to a method for processing a synchronized audio/video signal containing an auxiliary information component as will be described below with reference to FIG. 2.

Referring to FIG. 2, a method for processing a synchronized audio/video signal having a related auxiliary information component is illustrated. The method includes the steps of receiving the signal 102; separating the signal into an audio component, a video component and the auxiliary information component 104; extracting text data from the auxiliary information component 106 if necessary; analyzing the text data in an original language in which the signal was received 108; translating the text data stream into a target language 114; relating and formatting the translated text with the audio and video components; and displaying the translated text data while simultaneously displaying the video component and playing the audio component of said signal 120. Additionally, the method provides for analyzing the original text data and translated text data, determining whether a metaphor or slang term is present 110, and replaces the metaphor or slang term with standard terms representing the intended meaning 112. Further, the method determines if a particular term is repeated 116, and if the term is determined to be repeated, replaces the term with a different term of similar meaning in all occurrences after a first occurrence of the term 118. Optionally, the method provides for determining a part of speech the text data is classified as and displays the part of speech classification with the displayed translated text data.

While the present invention has been described in detail with reference to the preferred embodiments, they represent mere exemplary applications. Thus, it is to be clearly understood that many variations can be made by anyone having ordinary skill in the art while staying within the scope and spirit of the present invention as defined by the appended claims. For example, the auxiliary information component can be a separately transmitted signal which comprises timestamp information for synchronizing the auxiliary information component to the audio/video signal during viewing, or alternatively, the auxiliary information component can be extracted without separating the originally received signal into its various components. Additionally, the auxiliary information, audio, and video components can reside in different portions of a storage medium (i.e., floppy disk, hard drive, CD-ROM, etc.), wherein all components comprise timestamp information so all components can be synchronized during viewing.

What is claimed is:

1. A method for processing an audio/video signal and an auxiliary information signal comprising text data that is temporally related to the audio/video signal, said method comprising the steps of:
sequentially analyzing portions of said text data in an original language in which said text data is received;
sequentially translating said portions of text data into a target language; and
displaying said portions of translated text data while simultaneously playing the audio/video signal that is temporally related to each of the portions.

2. A method as in claim 1, further comprising the step of
receiving said audio/video signal and said auxiliary information signal;
separating said audio/video signal into an audio component and a video component; and
filtering said text data from said auxiliary information signal.

3. A method as in claim 1, wherein the step of sequentially analyzing said portions of text data includes the step of determining where a term present in said portion of text data under analysis is repeated and if the term is determined to be repeated, replacing the term with a different term of similar meaning in all occurrences after a first occurrence of the term.

4. A method as in claim 1, wherein the step of sequentially analyzing said portions of text data includes the step of determining whether one of a colloquialism and metaphor is present in said portion of text data under consideration, and replacing said ambiguity with standard terms representing the intended meaning.

5. A method as in claim 1, further comprising the step of sequentially analyzing said portions of translated text data and determining whether one of a colloquialism and metaphor is present in said portions of translated text data, and replacing said ambiguity with standard terms representing the intended meaning.

6. A method as in claim 1, wherein the step of sequentially analyzing said portions of text data includes the step of determining parts of speech of words in said portion of text data under consideration and displaying the part of speech with the displayed translated text data.

7. A method as in claim 1, further comprising the step of analyzing said portions of text data and said portions of translated text data by consulting a cultural and historical knowledge database and displaying the analysis results.

8. A method as in claim 2, wherein said text data is closed captions, speech-to-text transcriptions or OCR-ed superimposed text present in said video component.

9. A method as in claim 1, wherein said synchronized audio/video signal is a radio/television signal, a satellite feed, a digital data stream or signal from a video cassette recorder.

10. A method as in claim 1, wherein said audio/video signal and said auxiliary information signal are received as an integrated signal and said method further comprises the step of separating the integrated signal into an audio component, a video component and an auxiliary information component.

11. A method as in claim 10, wherein said text data is separated from other auxiliary data.

12. A method as in claim 10, wherein said audio component, said video component and said auxiliary information component are synchronized.

13. A method as in claim 1, further comprising the step of setting a personal preference level for determining a level of difficulty in which to perform the step of sequentially translating said portions of text data into the target language.

14. A method as in claim 13, wherein the level of difficulty is automatically increased based on a predetermined number of occurrences of similar terms.

15. A method as in claim 13, wherein the level of difficulty is automatically increased based on a predetermined period of time.

16. An apparatus for processing an audio/video signal and an auxiliary information component comprising text data that is temporally related to the audio/video signal, said apparatus comprising:
one or more filters for separating said signals into an audio component, a video component and related text data;
a microprocessor for analyzing portions of said text data in an original language in which said text data is received, the microprocessor having software for translating said portions of text data into a target language and formatting the video component and related translated text data for output;
display for displaying the portions of the translated text data while simultaneously displaying the video component; and
amplifier for playing the audio component of said signal that is temporally related to each of the portions.

17. An apparatus as in claim 16, further comprising:
a receiver for receiving said signals; and
a filter for extracting text data from said auxiliary information component.

18. An apparatus as in claim 16, further comprising a memory for storing a plurality of language databases, wherein said language databases include a metaphor interpreter.

19. An apparatus as in claim 16, wherein said language databases include a thesaurus.

20. An apparatus as in claim 18, wherein said memory further stores a plurality of cultural/historical knowledge databases cross-referenced to said language databases.

21. An apparatus as in claim 16, wherein the microprocessor further comprises parser software for describing said portions of text data by stating its part of speech, form and syntactical relationships in a sentence.

22. An apparatus as in claim 16, wherein the microprocessor determines whether one of a colloquialism and metaphor is present in said portion of text data under consideration and said portions of translated text data, and replaces said ambiguity with standard terms representing the intended meaning.

23. An apparatus as in claim 16, wherein the microprocessor sets a personal preference level for determining a level of difficulty for translating said portions of text data into the target language.

24. An apparatus as in claim 23, wherein the microprocessor automatically increases the level of difficulty based on a predetermined number of occurrences of similar terms.

25. An apparatus as in claim 23, wherein the microprocessor automatically increases the level of difficulty based on a predetermined period of time.

26. A receiver for processing a synchronized audio/video signal containing an auxiliary information component that is temporally related to said audio/video signal, said receiver comprising:
input means for receiving said signal;
demultiplexing means for separating said signal into an audio component, a video component and said auxiliary information component;
filtering means for extracting text data from said auxiliary information component;
a microprocessor for analyzing said text data in an original language in which said signal was received;
translating means for translating said text data into a target language; and
output means for outputting the translated text data, the video component and the audio component of said signal to a device including display means and audio means.
